(19) United States
(12) Patent Application Publication
(10) Pub. No.: US 2007/0065094 A1
(43) Pub. Date: Mar. 22, 2007

(54) MULTIMEDIA PROJECTION APPARATUS AND PLAYING METHOD THEREOF

(75) Inventors: Wen-Chang Chien, Hsinchu (TW); Wu-Hung Lin, Hsinchu (TW)

Correspondence Address: J C PATENTS, INC., 4 VENTURE, SUITE 250, IRVINE, CA, 92618, US

(73) Assignee: CORETRONIC CORPORATION, Hsinchu (TW)

(21) Appl. No.: 11/466,847

(22) Filed: Aug. 24, 2006

(30) Foreign Application Priority Data
Sep. 21, 2005 (TW) 94132610

(51) Int. Cl. H04N 5/91

(52) U.S. Cl. 386/46

(57) ABSTRACT

A multimedia projection apparatus with audio/video playing function includes a host module, a projection system, an audio/video switch and a playing module. The projection system is suitable for outputting a lighting-up signal to the host module, the audio/video switch is suitable for outputting a control signal to the host module according to different usage modes. In addition, the playing module is coupled to the host module and used for conducting a logic operation on the lighting-up signal and the control signal and outputting a driving signal to the playing module. The multimedia projection apparatus of the present invention is able to perform an audio/video function according to the above-described signals and select an audio/video function according to user requirements.

### CROSS-REFERENCE TO RELATED APPLICATION

This application claims the priority benefit of Taiwan application serial no. 94132610, filed on Sep. 21, 2005. All disclosure of the Taiwan application is incorporated herein by reference.

### BACKGROUND OF THE INVENTION

1. Field of Invention

The present invention relates to a projection apparatus, and particularly to a multimedia projection apparatus with audio/video playing function.

1. Description of the Related Art

The multimedia projection apparatus recently available in the market is mostly formed by a VCD player (video compact disk player) or a DVD player (digital video disk player) built in a projection apparatus. The VCD player or the DVD player is used for playing multimedia files as the images of the multimedia files are projected onto a screen, such that a family can enjoy audio/video broadcast at home.

However, in most of the current multimedia projection apparatuses, the audio function and the video function thereof still cannot run independently. When a user only requires the audio function, it is mandatory to start the multimedia projection apparatus first to play the audio, while the projection system of the multimedia projection apparatus is also turned on. Thus, the projection system is still operation even though the video function is not required, which reduces the lifetime of the projection apparatus and increases power consumption.

In addition, the projection system of the multimedia projection apparatus requires a warming-up time prior to operation; that is, only after an appropriate time the video clips of a multimedia file are able to be projected onto a screen. On the other hand, the audio/video player in the multimedia projection apparatus is ready to play the audio clips of the multimedia file once the multimedia projection apparatus is turned on, which causes a brief asynchronism between audio streaming and video streaming when playing a multimedia file.

In addition, in a conventional multimedia projection apparatus, the power cord thereof is mostly provided separately. To use a multimedia projection apparatus, the multimedia projection apparatus must be connected to a power supply by the power cord, which is inconvenient for a user, causes power cord storage hassle, and increases the possibility of losing the power cord.

### SUMMARY OF THE INVENTION

An object of the present invention is to provide a multimedia projection apparatus capable of running the audio function or the video function separately and playing audio and video clips of a multimedia file simultaneously.

Another object of the present invention is to provide a multimedia projection apparatus equipped with a built-in power cord to avoid power cord storage hassle and possibility of losing the power cord.

A further object of the present invention is to provide a method of playing the multimedia projection apparatus, for the multimedia projection apparatus to play the audio and video clips of a multimedia file simultaneously and to run the audio clips separately.

To reach the above-described objects of the present invention or the others, the present invention provides a multimedia projection apparatus and a playing method thereof, with audio/video playing functions. The multimedia projection apparatus includes a host module, a projection system, an audio/video switch and a playing module. The projection system is used for outputting a lighting-up signal to the host module, the audio/video switch is used for outputting a control signal to the host module according to different usage modes. Besides, the playing module is coupled to the host module, and the host module is used for conducting a logic operation on the lighting-up signal and the control signal to output a corresponding driving signal to the playing module.

In the multimedia projection apparatus of the present invention, a Boolean expression relating the lighting-up signal S1, the control signal S2 and the driving signal S3 is, for example, S3=S1·S2′. In a preferred embodiment, as the projection system has not sent the lighting-up signal or fails to send the signal, S1=TRUE, as the projection system has successfully sent the lighting-up signal, S1=FALSE; when the audio/video switch switches to an audio status, S2=TRUE, while the audio/video switch switches to a video status, S2=FALSE; as S3=TRUE, the playing module is disabled, while S3=FALSE, the playing module is enabled.

The above-described multimedia projection apparatus further includes a case to accommodate the host module, the projection system and the playing module. The multimedia projection apparatus further includes a power cord, disposed inside the case and coupled to the host module. The playing module is, for example, an audio playing module.

Based on the above-described, the multimedia projection apparatus of the present invention produces a driving signal according to a lighting-up signal and an externally input control signal for playing the audio/video function. In this way, the multimedia projection apparatus is able to select a desired playing mode, such as playing the audio clips separately, or simultaneously outputting audio/video clips of a multimedia file. In addition, the present invention allows a built-in power cord to be optionally disposed inside the multimedia projection apparatus to avoid the power cord storage hassle and the possibility of losing the power cord.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a block diagram of a multimedia projection apparatus according to an embodiment of the present invention.

FIG. 2 is a flowchart of a multimedia playing method according to the embodiment of the present invention.

FIG. 3 is a diagram of a multimedia projection apparatus in FIG. 1.

### DESCRIPTION OF THE EMBODIMENTS

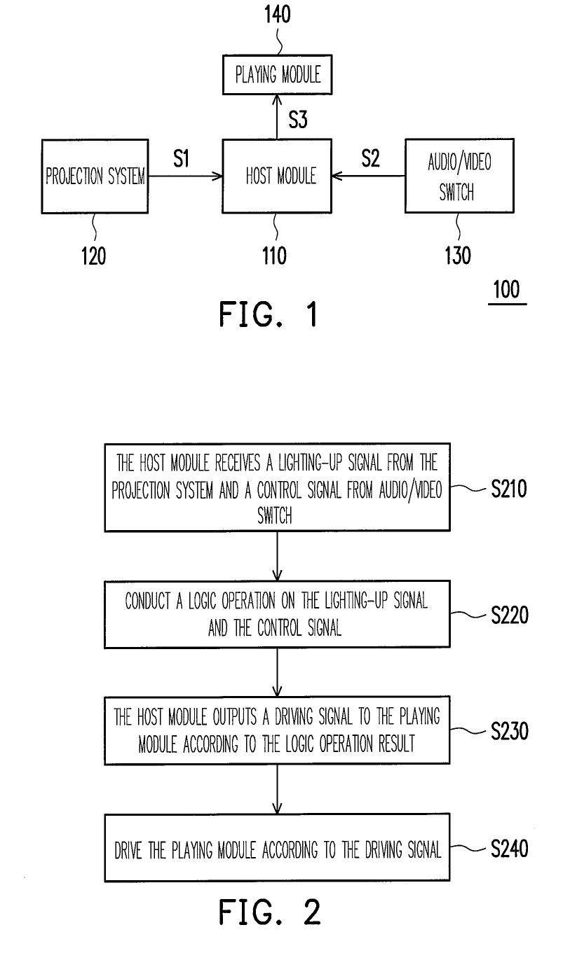

Referring to FIG. 1, a block diagram of a multimedia projection apparatus in an embodiment of the present invention is shown. The multimedia projection apparatus 100 having audio/video playing function includes a host module 110, a projection system 120, an audio/video switch 130 and a playing module 140. The projection system 120 is used for projecting video onto a screen (not shown) and outputting a lighting-up signal to the host module 110. The audio/video switch 130 is for the user to select either the audio mode or video mode and for outputting a control signal to the host module 110. The playing module 140 is coupled to the host module 110 for playing audio clips, and the playing module 140 is, for example, an audio playing module.

In addition, the multimedia projection apparatus 100 of the present invention is able to employ a multimedia playing method to perform the playing function. Referring to FIG. 2, first at step S210, the host module 110 receives a lighting-up signal from the projection system 120 and a control signal from the audio/video switch 130. Next at step S220, the host module 110 conducts a logic operation on the lighting-up signal and the control signal. Afterwards, at step S230, the host module 110 outputs a corresponding driving signal to the playing module 140 according to the logic operation result. Finally at step S240, the playing module 140 is driven by the driving signal.

To explain the above-described multimedia playing method in more details, please refer to FIGS. 1 and 2. It is noted that in the multimedia projection apparatus 100 of the present invention, the lighting-up signal S1, the control signal S2 and the driving signal S3 can be given by a Boolean expression of S3=S1·S2′. When the projection system 120 has not sent a lighting-up signal or fails to send a lighting-up signal, S1=TRUE, as the projection system 120 has successfully sent a lighting-up signal, S1=FALSE; as the audio/video switch 130 switches to an audio status, S2=TRUE, while the audio/video switch switches to a video status, S2=FALSE; as S2=TRUE, the playing module 140 is disabled, while S3=FALSE, the playing module 140 is enabled. In the present invention, Boolean value being TRUE of the signals S1, S2 and S3, means a high-level of the signals, while Boolean value being FALSE of the signals S1, S2 and S3 means a low-level of the signals.

The following table lists the various performing status of the multimedia projection apparatus 100 in the present invention corresponding to various combinations of the lighting-up signal S1, the control signal S2 and the driving signal S3.

| Status | S1 | S2 | S3 | system operation status |
|---|---|---|---|---|
| 1 | TRUE | TRUE | FALSE | The playing module enabled alone; |
| | | | | the projection system disabled |
| 2 | TRUE | FALSE | TRUE | Both the playing module and the |
| | | | | projection system disabled |
| 3 | FALSE | TRUE | FALSE | The playing module enabled alone |
| 4 | FALSE | FALSE | FALSE | Both the playing module and the |
| | | | | projection system enabled |

From the above table, it is seen that the status 1 of the multimedia projection apparatus 100 indicates the projection system 120 has not sent the lighting-up signal or fails to send the lighting-up signal (S1=TRUE), the audio/video switch 130 switches to audio status (S2=TRUE) and the playing module 140 is enabled (S3=FALSE), which means the playing module 140 runs alone.

The status 2 of the multimedia projection apparatus 100 indicates the projection system 120 has not sent the lighting-up signal or fails to send the lighting-up signal (S1=TRUE), the audio/video switch 130 switches to video status (S2=FALSE) and the playing module 140 is disabled (S3=TRUE), which means that neither the playing module 140 nor the projection system 120 runs.

The status 3 of the multimedia projection apparatus 100 indicates that the audio/video switch 130 switches to an audio status (S2=TRUE) and, regardless of whether the projection system 120 has not sent the lighting-up signal or fails to send the lighting-up signal (S1=TRUE), or the projection system 120 has sent the lighting-up signal (S1=FALSE), the playing module 140 is enabled (S3=FALSE). Therefore, as the audio/video switch 130 switches to audio status (S2=TRUE), the playing module 140 is ready for operation, but at this point, the projection system 120 needs to warm up and then is able to project video onto a screen (not shown).

The status 4 of the multimedia projection apparatus 100 indicates the audio/video switch 130 switches to a video status (S2=FALSE). Therefore, only after the projection system 120 sends the lighting-up signal (S1=FALSE), the driving signal S3=FALSE, which means that the playing module 140 is able to be enabled and both the playing module 140 and the projection system 120 operate simultaneously.

It is noted that the multimedia projection apparatus 100 of the embodiment produces a driving signal according to a lighting-up signal and an externally input control signal to perform the audio/video function.

If the audio playing mode is desired, the audio/video switch 130 must switch to an audio status, so as to enable the playing module 140. In this way, the running of the projection system 120 is avoided when only audio function is desired. This obviously lengthens the lifetime of the projection system 120 and saves power consumption. On the other hand, for both audio and video clips to be simultaneously played, the audio/video switch 130 must have to switch to a video status and after the projection system 120 has sent a lighting-up signal, the playing module 140 is ready to play the audio clip. At this point, both the audio and video clips are played simultaneously. Therefore, asynchronism between audio streaming and video streaming is avoided in the multimedia projection apparatus 100. Such asynchronism takes place when the projection system 120 is warming up, but the playing module 140 is playing the audio clip already.

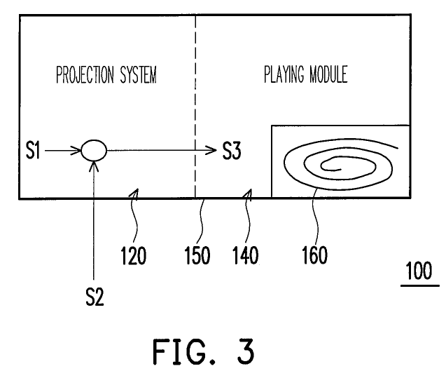

Referring to FIG. 3, it is a diagram of a multimedia projection apparatus in FIG. 1. The multimedia projection apparatus 100 according to the embodiment of the present invention further includes, for example, a case 150, wherein the host module 110 (as shown in FIG. 1), the projection system 120 and the playing module 110 (as shown in FIG. 1) are disposed in the case 150. The case 150 prevents the host module 110, the projection system 120 and the playing module 110 from collisions, which affects normal operations of the multimedia projection apparatus 100. Besides, the multimedia projection apparatus 100 includes a power cord 160 disposed in the case 150 and coupled to the host module 110 (as shown in FIG. 1). As a result, when using the multimedia projection apparatus 100, no extra power cord is needed, and the power cord storage hassle and possibility of losing the power cord is avoided.

In summary, in the multimedia projection apparatus of the present invention, a driving signal is produced according to a lighting-up signal and a externally input control signal. By means of the produced driving signal, the audio/video function is selected and performed. Compared with the prior art, the multimedia projection apparatus of the present invention allows the user to select a playing mode, for example, playing the audio function alone, thus lengthening the lifetime of the projection system and saving power consumption; or simultaneously outputting audio and video of a multimedia file. Thus, the user has more choices when using the multimedia projection apparatus. Besides, the multimedia projection apparatus of the present invention is equipped with a built-in power cord, which avoids the power cord storage hassle and the possibility of losing the power cord.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A multimedia projection apparatus with audio/video playing function, comprising:
a host module;
a projection system, suitable for outputting a lighting-up signal to the host module;
an audio/video switch, suitable for outputting a control signal to the host module according to different usage mode; and
a playing module, coupled to the host module, wherein the host module is used for conducting a logic operation on the lighting-up signal and the control signal and for outputting a corresponding driving signal to the playing module.

2. The multimedia projection apparatus as recited in claim 1, wherein the lighting-up signal, the control signal and the driving signal are given by a Boolean expression of S3=S1·S2′, wherein S1 indicates the lighting-up signal, S2 indicates the control signal, S3 indicates the driving signal.

3. The multimedia projection apparatus as recited in claim 2, wherein as the projection system has not sent a lighting-up signal or fails to send a lighting-up signal, S1=TRUE, and as the projection system has sent a lighting-up signal, S1=FALSE; as the audio/video switch switches to an audio status, S2=TRUE, and as the audio/video switch switches to a video status, S2=FALSE; as S3=TRUE, the playing module is disabled, while as S3=FALSE, the playing module is enabled.

4. The multimedia projection apparatus as recited in claim 1, further comprising a case, wherein the host module, the projection system and the playing module are disposed inside the case.

5. The multimedia projection apparatus as recited in claim 4, further comprising a power cord, wherein the power cord is disposed inside the case and coupled to the host module.

6. The multimedia projection apparatus as recited in claim 1, wherein the playing module comprises an audio playing module.

7. A multimedia playing method, suitable for a multimedia projection apparatus, wherein the multimedia projection apparatus comprises a projection system, an audio/video switch and a playing module, wherein the projection system is suitable for outputting a lighting-up signal and the audio/video switch is suitable for outputting a control signal according to different usage mode; the method comprising:
receiving the lighting-up signal from the projection system and the control signal from the audio/video switch and conducting a logic operation on the lighting-up signal and the control signal; and
according to the logic operation result, outputting a corresponding driving signal to drive the playing module.

8. A multimedia playing method as recited in claim 7, wherein the lighting-up signal, the control signal and the driving signal are given by a Boolean expression as S3=S1·S2′, where S1 indicates the lighting-up signal, S2 indicates the control signal, S3 indicates the driving signal.

9. A multimedia playing method as recited in claim 8, wherein as the projection system has not sent a lighting-up signal or fails to send a lighting-up signal, S1=TRUE, and as the projection system has sent a lighting-up signal, S1=FALSE; as the audio/video switch switches to an audio status, S2=TRUE, while as the audio/video switch switches to a video status, S2=FALSE; as S3=TRUE, the playing module is disabled, while as S3=FALSE, the playing module is enabled.
